(19) United States
(12) Patent Application Publication
(10) Pub. No.: US 2009/0319304 A1
(43) Pub. Date: Dec. 24, 2009

(54) EVENT SCHEDULING METHOD AND SYSTEM

(76) Inventor: Daniel R. Smith, Cincinnati, OH (US)

Correspondence Address: Douglas A. Scholer, 7005 Eschol Ct., Wilmington, NC, 28409, US

(21) Appl. No.: 12/143,870

(22) Filed: Jun. 23, 2008

(51) Int. Cl. G06Q 10/00

(52) U.S. Cl. 705/5; 705/8

(57) ABSTRACT

A computer implemented method, apparatus and program product automatically schedule events by generating templates of participant pairings based on scheduling stipulations, preferences or other constraints. The generated templates do not typically include any time or location information, which is later combined with the template to form the schedule. Constraints used to generate the template pairings may include secondary match-ups, or pairings, that do not meet a primary preference of a participant. Other constraints may include weighted time slot designators, repeat pairings, crossover games between different leagues, as well as meeting times. The template feature enables constraints to be satisfied before the parings are associated with times.

### CROSS REFERENCE TO RELATED APPLICATIONS

This application claims the benefit of priority to Utility patent application Ser. No. 11/250,056, entitled “System for Automatically Scheduling Events,” filed Oct. 13, 2005 by Daniel R. Smith, and which claims the benefit of priority to Provisional Patent Application No. 60/622,031, entitled the same and filed on Oct. 26, 2004, both applications are incorporated herein by reference in their entireties.

### FIELD OF THE INVENTION

The present invention generally relates to computer implemented programs and related technologies, and more particularly, to computer programs used to automatically schedule events involving a number of participants.

### BACKGROUND OF THE INVENTION

The popularity of organized sports has spawned a growing industry of providing venues for competition. The increasing demand for facilities has made it common for a single venue resource, e.g., a field, a court, etc., to accommodate multiple league competitions and multiple sports. Because the venue must be shared at different times among the different competitors, access to the venue has become a premium commodity. Maximizing the use of any given venue is directly related to the financial success of the facility. Venue availability is important for both the convenience and enjoyment of participants, as well as for the financial success of the venue. To be successful, it is generally incumbent upon the facility manager to efficiently schedule events while maximizing the number of participants.

While some computer programs have been developed to assist facility managers, scheduling remains an arduous task. Conventional programs initially construct a schedule according to a fixed or limited number of templates for a single league, and then attempt to use the available time slots at a facility. After the framework of the schedule has been established, a conventional program will attempt to assign participants from that single league to the set time slots of the schedule. This task quickly becomes complicated with the introduction of unique preferences, requirements, and other constraints of each participant, team or league. For instance, certain participants may prefer to play on a certain day or time not used by the majority in a given league, and may be unable to compete during other times. It may be desirable to include a bye on a certain day, a particular match-up or rematch, and/or a crossover game between teams in different leagues, among other preferences. Thus, it becomes a very complicated balancing act between accommodating customer preferences, creating an overall balanced schedule for all participants, and maximizing the primary commodity of time.

Attempting to assign the participants to the time slots while meeting such constraints is exceedingly challenging. A scheduler using conventional programming techniques may not appreciate the subtle interactions of all the constraints until after initial assignments have already been locked in. In such instances, it may soon be mathematically/programmatically impossible to realize subsequent constraints after those initial stipulations. Conventional programs routinely fail to meet particular constraints, and cannot provide mechanisms for allowing, for instance, cross league play, pre-set games, or scheduling involving complex preferences.

As a result, the facility manager is often relegated to the difficult and time consuming task of manually scheduling time slots. Often, resultant schedules fail to meet expectations of participants and facility managers alike, and result in the venue being under utilized because of vacant time slots or downtime. Because the manual scheduling processes are time consuming, the facility is unable to take on additional participants once the manual scheduling process has started. Consequently, there exists a need for an improved manner of automatically scheduling events.

### SUMMARY OF THE INVENTION

The present invention provides an improved computer implemented method, apparatus and program product for automatically scheduling events by generating a plurality of templates of participant pairings based on scheduling stipulations, preferences or other constraints. First and second templates may be associated with respective constraints. For instance, one template may include pairings and secondary allocations, while another template may include pairings associated with weighted constraints. Each template may be one of a number of templates generated according to the respective constraint. The best template of each group may be selected and combined with the best of the other group to create a reconciled template. Where desired, any necessary pairing information absent from the reconciled template may be automatically generated to form a final template.

Prior to the final template, each template may be partial in the sense that it may not include all the pairing information that will be used to generate a final template. The generated templates do not initially include any time or location information. Such time and/or location information may later be combined with the templates to form the schedule. The system may automatically determine which of the partial templates may be combined or otherwise reconciled to produce the best results. The combined, or reconciled template may then be automatically associated with a plurality of time slots associated with the venue at which the events are to take place.

Constraints used to generate the template pairings may include secondary pairings comprising pairings that do not meet a primary preference of a participant. That is, a pairing may be associated with a designator that will later be associated with a less preferred time slot. For instance, a team that would prefer to play all games on Saturdays may have a less preferred, secondary preference of Tuesdays. A corresponding secondary pairing may include a pairing that includes that team associated with a designator that will ultimately translate into a Tuesday event. Other exemplary constraints may include repeat pairings, as well as preferred meeting clock times.

Constraints comprising time slot preferences may be weighted. Input time slots preferred by users may also be weighted, thereby creating additional constraints. For example, the user may opt to assign weight factors up to the first three, last three, or no time slots. Programmatic constraint processing enables scheduling balance or other desired qualities either for individual teams or across the entire league group. The template feature enables constraints to be satisfied before the parings are associated with specific dates and times.

Aspects of the invention include embodiments that accommodate crossover games between different leagues and enable schedulers to arrange repeat pairings/rematches within a session. Moreover, embodiments allow standard scheduling requests, for instance, a bye on a given week, or a prescheduled/preset, mandatory pairing. Embodiments may balance early and late games in a league group based on user input, and enable tournament play at the end of a regular season if desired for some leagues.

More particularly, aspects of the invention schedule events involving a plurality of participants by, in part, receiving a constraint associated with at least one of the plurality of participants. An association with a participant for purposes of this specification may include an association with a group or other logical construct that, in turn, is associated with a participant. Embodiments generate, based on the constraint, a plurality of templates comprising pairings between the participants. The templates may be partial in the sense that some pairings of participants that will be present in the final schedule are not present. The system may automatically determined which of the partial templates may be combined or otherwise reconciled to produce the best results. The combined, or reconciled template may then be automatically associated with a plurality of time slots associated the venue at which the events are to take place. Ultimately, features of the invention enable a schedule comprising the pairings assigned to the time slots to be generated and output.

In some embodiments, the constraint comprises a preference selected from a group consisting of: the date of the event, a time of day for the event, a pairing, a relative sequence of the pairing compared to another pairing, and a ranking. As such, a constraint may be associated with a frequency of how often a preference will be realized or unrealized. Constraints routinely include primary and secondary preference allocations.

The constraint may be assigned to one or more of a league, a team, a plurality of leagues and participants. In crossover game scenarios, the constraint may be associated with participants that belong to respective teams of different leagues. Moreover, constraint may be weighted with respect to early or late time slots and/or automatically generated, e.g., where a user entered constraint does not produce desired scheduling results.

Embodiments may further balance home and away games. For example, duplicate games may be one home game and one away game per team. By cross-referencing multiple data fields, embodiments may avoid conflicts between two teams, one coach, two different fields, and overlapping times. Embodiments may additionally accommodate various intervals between events, e.g., games per cycle (day/week/month).

Aspects of the invention may further accommodate preset competitions. With program code optimized to handle the aforementioned preset games, additional teams may be accepted at the last minute, again maximizing time slots available and resulting in additional income to the facility.

These and other advantages and features which characterize the invention are set forth in the claims annexed hereto and forming a further part hereof. However, for a better understanding of the invention, and of the advantages and objectives attained through its use, reference should be made to the Drawings, and to the accompanying descriptive matter, in which there are described exemplary embodiments of the invention.

### BRIEF DESCRIPTION OF THE DRAWINGS

FIG. 1 is a block diagram of a computer system configured to facilitate event scheduling in accordance with the principles of the present invention.

FIG. 2 is a flowchart having steps for automatically creating a template used to schedule events at a venue.

FIG. 3 shows an exemplary computer screen displayed by the system of FIG. 1 and configured to prompt input from a scheduler regarding the allocation of primary and secondary games as outlined in the text describing FIG. 2.

FIG. 4 shows an exemplary computer screen displayed by the system of FIG. 1 and configured to prompt input from a scheduler regarding weighting constraints as outlined in the text describing FIG. 2.

FIG. 5 shows a partial template that may be generated by the system of FIG. 1 in accordance with a programmatic constraint and the underlying principals of the present invention.

FIG. 6 shows another partial template that may be generated by the system of FIG. 1 in accordance with another programmatic constraint and the underlying principals of the present invention.

FIG. 7 shows a reconciled template that may be generated by the system of FIG. 1 as a combination of the templates of FIGS. 5 and 6.

FIG. 8 shows a final template that may be generated by the system of FIG. 1 in accordance with the underlying principals of the present invention.

### DETAILED DESCRIPTION

Embodiments automatically schedule events by generating a plurality of templates of participant pairings based on scheduling stipulations, preferences, or other constraints. The generated templates do not initially include any actual time or location information; this information is later combined with the template to form the schedule. Constraints used to generate the template pairings may include secondary match-ups, or pairings, that do not meet the primary preference for the league group. Secondary pairings are used as a result of participant preference to maximize faculty use. Other constraints may include repeat (duplicate) pairings, as well as meeting times. Constraints comprising time slot information may be weighted to optimize scheduling preferences. Notably, the template feature and associated scheduling sequences enable constraints to be satisfied before the parings are associated with actual time slots.

Embodiments consistent with the invention approach scheduling from an opposite approach than conventional scheduling systems. In so doing, embodiments accommodate scheduling constraints that are commonplace in today's sports scheduling environment. Notably, such constraints include teams playing on secondary days of play, crossover games between leagues, first games already scheduled, and preset games. Conventional programs struggle in this regard because they force the above conditions into a preexisting and fixed or limited listing of scheduled time slots and try to arrive at a working arrangement. Such conventional methodologies begin to fail as additional considerations are added to a scheduling scenario, and do not work at all when working with multiple leagues sharing common time slots.

Embodiments of the present invention approach scheduling from an opposite approach, in that constraints, (e.g., required, secondary, crossover, first, and/or duplicate pairings) are entered without specific regard to time slots of conventional schedules. That is, the template is first generated around the constraints. With the constraints built into the template, and the template thus built to fit the match-ups, the match-ups required to meet the constraints are in place before any shuffling or permutations. Templates for all leagues in a league group may be determined, despite each being dependent on the other relative to initial, available slots and for keeping all restrictions valid. As a result, the number of permutations required are greatly reduced, if needed at all. By creating a template that already has most of the constraints in place to make it work, embodiments are better able to approach challenging scheduling scenarios.

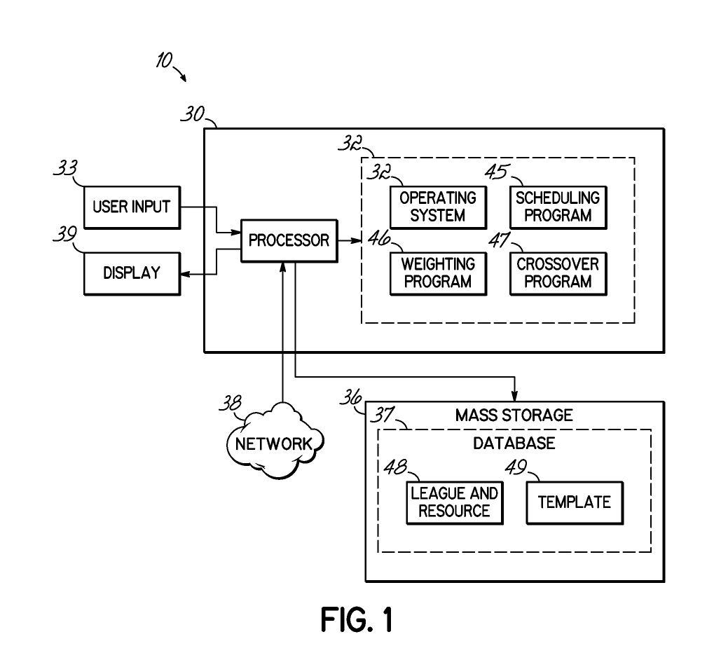

While the principles of this invention do not limit its forum or application, one desirable scheduling embodiment capitalizes on the structure available through the computer system exemplified in FIG. 1. FIG. 1 generally shows a block diagram of a networked computer system 10 configured to facilitate a scheduling process. The system 10 more particularly comprises one or more client computer(s) 30 coupled to a network 38. Network 38 represents a networked interconnection, including, but not limited to local area, wide area, wireless, and public networks (e.g., the Internet). Moreover, any number of computers and other devices may be networked through network 38, e.g., multiple servers. For instance, network 38 may communicate with networked devices located at a regional sports center and/or a remote office.

Computer system 10 will hereinafter also be referred to as an “apparatus,” “computer,” “tool,” or “scheduling system,” although it should be appreciated that the terms may respectively include many other controller configurations. Moreover, while only one network interface device is shown in FIG. 1, any number of computers and other devices may be networked through network 38. In still another embodiment, the system 10 may be implemented in a stand alone configuration, i.e., disconnected from another computer or computer network.

Computer 30 typically includes at least one processor 44 coupled to a memory 32. Processor 44 may represent one or more processors (e.g., microprocessors), and memory 32 may represent the random access memory (RAM) devices comprising the main storage of computer 30, as well as any supplemental levels of memory, e.g., cache memories, non-volatile or backup memories (e.g., programmable or flash memories), read-only memories, etc. In addition, memory 32 may be considered to include memory storage physically located elsewhere in computer 30, e.g., any cache memory present in processor 44, as well as any storage capacity used as a virtual memory, e.g., as stored within a database 37, or on another computer coupled to computer 30 via network 38. For instance, exemplary database 37 may include league and resource information 48, as well as one or more template(s) 49.

Computer 30 also may receive a number of inputs and outputs for communicating information externally. For interface with a user, computer 30 typically includes one or more input devices 33 (e.g., a keyboard, a mouse, a trackball, a joystick, a touch pad, iris/fingerprint scanner, and/or a microphone, among others). The computer 30 additionally includes a display 39 (e.g., a CRT monitor, an LCD display panel, and/or a speaker, among others). It should be appreciated, however, that with some implementations of the computer 30, direct user input and output may be unsupported by the computer, and interface with the server computer 30 may be implemented through a computer or workstation networked with the computer 30.

For additional storage, computer 30 may also include one or more mass storage devices 36 configured to store, for instance, the database 37. Exemplary devices 36 can include: a floppy or other removable disk drive, a flash drive, a hard disk drive, a direct access storage device (DASD), an optical drive (e.g., a CD drive, a DVD drive, etc.), and/or a tape drive, among others. Furthermore, computer 30 may include an interface with one or more networks (e.g., a LAN, a WAN, a wireless network, and/or the Internet, among others) to permit the communication of information with other computers coupled to the network 38. It should be appreciated that computer 30 typically includes suitable analog and/or digital interfaces between processor 44 and each of the components 32, 33, 36, 38 and 39.

Computer 30 operates under the control of an operating system 40, and executes various computer software applications, components, programs, modules, e.g., a scheduling program 45, weighting program 46 and crossover program 47, among others. Various applications, components, programs, markers, modules, etc. may also execute on one or more processors in another computer coupled to computer 30 via a network 38, e.g., in a distributed or client server computing environment, whereby the processing required to implement the functions of a computer program may be allocated to multiple computers over a network.

In general, the routines executed to implement the embodiments of the invention, whether implemented as part of an operating system or a specific application, component, program, engine, process, programmatic tool, object, module or sequence of instructions, or even a subset thereof, may be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. One of skill in the art should appreciate that embodiments consistent with principles of the present invention may nonetheless use program code resident at only one, or any number of locations.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable, signal bearing media used to actually carry out the distribution. Examples of signal bearing, computer readable media include, but are not limited to tangible, recordable type media such as volatile and non volatile memory devices, floppy and other removable disks, hard disk drives, magnetic tape, optical disks (e.g., CD ROMs, DVDs, etc.), among others, and transmission type media such as digital and analog communication links.

In addition, various program code described hereinafter may be identified based upon the application or engine within which it is implemented in a specific embodiment of the invention. However, it should be appreciated that any particular program nomenclature that follows is used merely for convenience, and thus the invention should not be limited to use solely in any specific application or engine identified and/or implied by such nomenclature.

Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

The various software components and resources illustrated in FIG. 1 may be implemented in a number of manners, including using various computer software applications, routines, components, programs, objects, modules, data structures and programs. Those skilled in the art will further recognize that the exemplary environments illustrated in FIG. 1 are not intended to limit the present invention. Indeed, those skilled in the art will recognize that other alternative hardware and/or software environments may be used without departing from the scope of the invention.

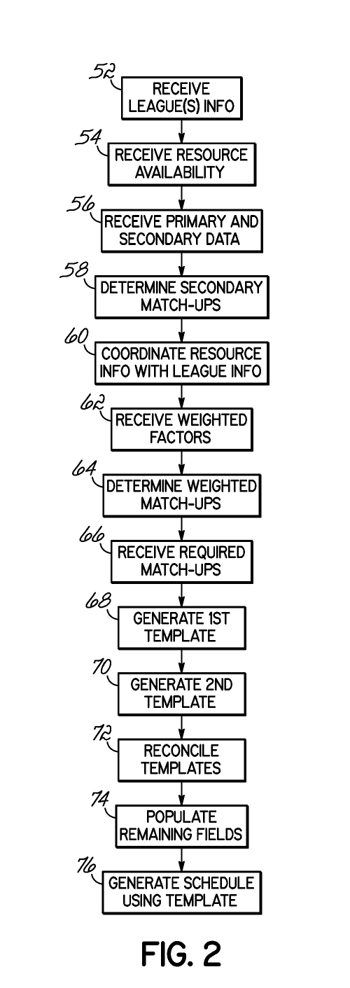

FIG. 2 is a flowchart 50 having steps for automatically creating a template used to schedule events at a venue(s). The flowchart 50 more particularly includes processes used by the system 10 of FIG. 1 for generating a schedule. In one preferred embodiment, the schedule is generated around pairings, as opposed to available time slots. As such, the steps of the flowchart 50 are used to automatically schedule events by generating one or more templates of participant pairings based on scheduling stipulations, preferences or other constraints. The generated template(s) does not initially include any time or location information; this information is later combined with the template(s) to form the schedule. Constraints used to generate the template pairings may include secondary match-ups or pairings that do not meet a primary preference of a participant, e.g., a secondary time slot. Other constraints may include repeat pairings and crossover games between different leagues, as well as meeting times. Time slot related information comprising constraints may be weighted. The template feature enables constraints to be satisfied before the parings are associated with times.

At block 52 of the flowchart 50, the system 10 may receive scheduler, or user, input comprising team and league information. For instance, user input may include names or other designators identifying teams and leagues. A league typically comprises a group of teams. The user may additionally assign teams to leagues, and leagues to groups at block 52. As such, a league group generally comprises an association of leagues sharing some common time slots in a venue. Embodiments of the scheduling program may start with a number of teams in a given league/bracket, and a number of leagues grouped together in a league group. The system may output a table of games.

More specifically, the system 10 may receive at block 52 data comprising teams and assigned coaches to be stored in the database. The scheduler may enter teams, assign coaches from a coach/customer list in a database, assign teams to a league, and assign leagues to a league group from a league group table. With each league, a number of games to play is typically entered (not including those associated with a tournament) and the duration of each game. The scheduler may be prompted to enter whether there will be a tournament, as well as whether there should be a crossover game between teams of different leagues. If so, the leagues involved in the crossover game may be identified by the scheduler.

The scheduler enters into the system 10 block 54 availability information relating to a venue, e.g., a field, court, or other resource where events are to take place. The system 10 may receive date and time information identifying when the venue or other resource is available for a league group to use. For instance, a session may extend from January 15th to March 27th. Moreover, embodiments may assign game times using a start time, a duration of a contest and an end time. For instance, 10 year-olds may play for 40 minutes, while 14 year-olds may play for 55 minutes. User input may be entered by league. The system 10 may receive all available time slots and dates possible. If more time slots are available than games, a hierarchy of rules are used to determine which are left blank.

At block 56 of FIG. 2, the scheduler may enter primary and secondary day of play allocations for each team within each league in the league group. A primary allocation may be used to determine with what frequency or relative proportion a team (or league) will participate at a given time slot(s) for the venue. The league group may have a primary day of play, e.g. Sunday. Teams in a particular league may have several regular and available time slots during which they may compete using the venue. For example, teams in the league may be permitted to compete regularly on Wednesdays, Thursdays and Sundays, with specific time slots generally available during those days. A scheduler at block 56 may allocate, or assign, a preferred time slot to a given team and/or league, e.g., a team prefers to compete at 3:00 P.M. on Sundays. A secondary allocation assigned to the same team and/or league may include a less preferred time slot(s), e.g., “evening” on Thursdays. The scheduler typically enters such primary and secondary allocations for each team in a league. Primary and secondary day allocations allow flexibility to accommodate scheduling preferences and facility maximization. For instance, a team may need to play all Saturday games, when the primary night of play for the team's league is Friday. The team's secondary game/preference constraint may comprise a designation associated with a Saturday game.

Primary and secondary logic is based on input of primary and secondary games for each team based on customer preference as well as maximization of facility scheduling. If there are no secondary time slots for a given league at block 56, this step may be omitted.

In addition to associating teams with primary and secondary allocations, the allocation at block 56 may additionally include a proportion of times a team should participate according to the primary and secondary allocations relative to other teams. For example, the scheduler may enter data during the allocation processes of block 56 stipulating that a first team should have five of seven contests in accordance with the team's first primary allocation. As such, the remaining two games for the first team will be played in accordance with the team's secondary allocation. Second and third teams may be allocated to play three of seven respective contests with the respective teams' primary allocation, with the remaining contests occurring according to the secondary allocation.

Primary and secondary allocations may thus be manually or automatically generated (e.g., through automatically populating allocation entry fields with default allocations) until primary and secondary allocations are accomplished for each team. In the case where allocations are automatically accomplished, default allocations may include assignments intended to equally distribute primary and secondary allocations as between teams and/or leagues.

The system 10 at block 58 may determine required secondary pairings necessary to make the allocation work. To this end, the system 10 may automatically iterate different mathematical and scheduling scenarios using, for instance, combination, fuzzy and/or sequential logic. Where mathematically possible, in this manner, the system 10 may create a data template/profile for the teams and their respective allocations.

In an instance where the entered allocations cannot be mathematically realized, the system 10 may automatically notify the user if the number of allocations is incorrect. The system 10 in such a scenario may additionally suggest secondary pairings that make the allocation work. For instance, the system 10 may generate and present a list of pairings that mathematically most closely track those allocations accomplished at block 56.

More particularly, the system 10 may check for accuracy, e.g., to make sure that an input allocation works logically for all primary/secondary slots within each league. The program code may total all primary/secondary games in a league group, then cross-reference that total with total slots. The system 10 may create the start of the template.

The system 10 may reconcile at block 60 the time slots with the league group configuration. Such reconciliation processes may include mathematically coordinating the number of teams, games and primary and secondary allocations. To this end, the system 10 may use combination, sequential and/or fuzzy logic, among other known techniques discussed herein to arrive at logical associations that accommodate the entered allocations. In this manner, primary and secondary allocations accomplished at block 58 may be made in a manner that accounts for and accommodates the entered time slot allocations of other teams in all other leagues.

If the number of teams, games and allocations cannot be reconciled at block 60, then the system 10 may automatically inform the user, and optionally suggest (using a pop up window, for instance) another allocation scheme or other change that works. This suggestion may be automatically generated by virtue of the system 10 selecting a change based on a list of generated possibilities.

At block 62 of the flowchart 50, the system 10 may receive weighted factors assigned to time slots (e.g., first 3, last 3, all, or none). It may also receive maximum games at a given time slot and desired teams, among other criteria/constraints that may be weighted or recurring in nature and apply to one or more teams. This feature enables the scheduler to realize specific preferences. For instance, a designed team may receive preferential scheduling.

The system 10 may use the weighted criteria/parameters to mathematically determine at block 64 match-ups to make the template work. As discussed herein, such determinations may include known logic techniques, and if determined to be impossible, the system 10 may prompt the scheduler with suggested alternatives.

Exemplary logic used to determine pairings may begin by taking the quantity of secondary pairings for each participant as input by the user. From these quantities, the code may derive all possible secondary pairings. These may be compiled in the form of a mini, or partial template. Depending on the quantities as input by the user, there may be a single partial template generated; at this point of the template generation, there may be no order or dates in the template, etc., only pairings, for instance.

At block 66, the system may receive games that are already scheduled, as well as any desired duplicate pairings. For instance, first games and/or byes for some teams may have been manually set up and previously scheduled. These are typically the first games, but may be anywhere in the schedule. For instance, a team may want to play on a particular day so that they can have a surprise party after the game for a teammate. In certain scenarios, it may be desirable to designate teams of different leagues to compete (a crossover match). Such pairings may be assigned within the developing template to ensure that they occur.

Assignments as such are possible, in part, due to the sequence in which the scheduling template is created. That is, the sequence of entering and determining data shown in the embodiment of FIG. 2 allows the data to be manipulated within the developing template in a manner that accommodates constraints not conventionally possible. For instance, to schedule a crossover game, a scheduler using conventional methods would typically have to generate several different, individual schedules, i.e., one for each league, by filling in available time slots in a relatively haphazard manner until the constraints were met. They would then have to go back to the individual schedules and manually determine some possible scheme that could be accomplished to both schedules without upsetting the rest of the schedule. In contrast, such crossover games are possible with features of the present invention by virtue of embodiments being able to address all the constraints of an entire league group at once, prior to marrying those constraints to actual time slots.

The system 10 may then generate at block 68 a first template with constraints in place. For example, the first template may include pairings associated with secondary constraints, or allocations. As such, the template may comprise a logical construct (e.g., logically linked fields of a database) of pairings and constraints associated with teams of the league group. The pairings and any byes may further be linked to cycles of a (still purely mathematical) session that may ultimately be associated at block 70 with actual time slots. The first template will typically not be complete. That is, some template fields linking teams and/or cycles may not contain data, as only secondary pairings per user input quantities by team may be contained in this partial template. A number of such templates may be generated. As discussed herein, the program code may analyze the partial templates (alone or in conjunction with a template having another constraint) to determine which may be best combined with the other template (having the other constraint) in a manner that preserves the most pairing constraints.

At block 70 the system 10 may generate a second template of pairings associated with another constraint associated with the league group. This second template may include different pairings by virtue of the different constraint. For example, the second template, or group of templates, may include weighted constraints. The constraint may be added as a result of a user desiring to balance early and/or late time slots for all teams in the league group. The additional constraints for the second template typically come from the user assigning weighted factors to undesirable time slots. The code may then determine the quantity that each team must play at each undesirable time slot, then create a partial template in identical fashion as the secondary partial template described in the preceding paragraph. As above, the match-ups/pairings and any byes may be linked to cycles of the season and there may be single or multiple partial templates.

The system 10 may reconcile the first and second templates at block 72. This process may include programmatically merging the respective match-ups of the templates. For example, the system 10 may consider all the partial templates of the respective groups generated at blocks 68 and 70 to determine which can be combined in a manner that best accommodates the pairings of each partial template generation step. By combining aspects of at least two templates, embodiments achieve needed flexibility to accommodate scheduling scenarios that confound conventional scheduling programs.

Some fields of the reconciled template may remain empty after the merger of the templates at block 72. For instance, an empty field of the template may regard a remaining pairing required to complete the cycle based on the number of teams in the league. Using an example with an eight team league, one additional pairing must be created to make that cycle valid (all valid cycles make a valid template). As such, the system 10 at block 74 may automatically populate any remaining fields of the reconciled template. For example, the system 10 may identify an empty field reflecting a needed pairing that was unaccounted for in the template generation and/or reconciliation process. Adding the appropriate pairing may be accomplished in a manner that keeps the cycle valid (teams playing only once). At block 74, the system 10 may enter a pairing and appropriate constraint information to complete the reconciled, or final template.

The system 10 may then at block 76 generate a schedule by marrying the template generated at block 74 with the actual time slots. These merger processes may include programmatically assigning slots to template fields and cycle information according to constraints linked to the fields.

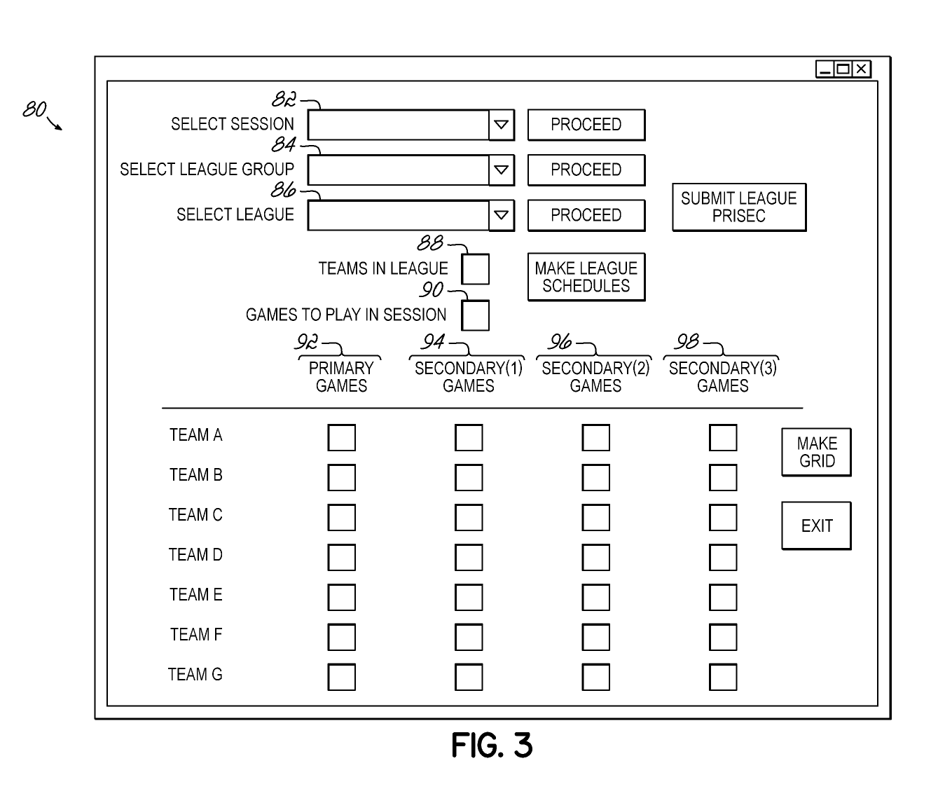

FIG. 3 shows an exemplary computer screen 80 displayed by the system 10 of FIG. 1 and configured to prompt input from a scheduler regarding the allocation of primary and secondary games as outlined in the text describing FIG. 2. More particularly, the computer screen 80 includes fields useful for assigning and reviewing primary and secondary allocations. In accomplishing the allocations, the scheduler may select a session from the pull down menu 82. Similarly, the scheduler may designate a lead group and league at fields 84 and 86, respectively.

The scheduler is prompted at block 88 to enter the teams in the league, as well as the games to play in the designated session at block 90. Where desired, scheduler may enter a number indicative of the times in the session that a particular team should play during a primary game slot at column 92. Secondary games for each team may be allocated using fields in columns 94, 96, and/or 98.

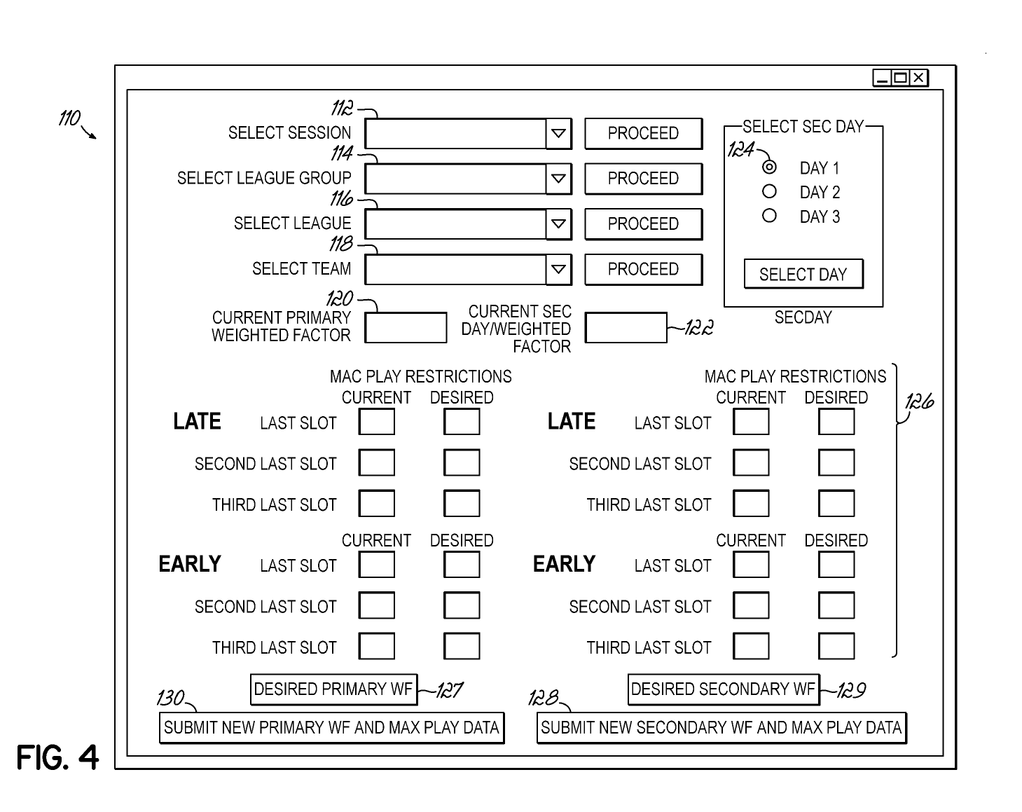

FIG. 4 shows an exemplary computer screen 110 displayed by the system 10 of FIG. 1 and configured to prompt input from a scheduler regarding weighting constraints as outlined in the text describing FIG. 2. More specifically, the computer screen 110 displays and allows manipulation of constraints using weighted factors. Turning to the exemplary computer screen 110, a scheduler may select a session, group, league, team and day from input menus 112, 114, 116, 118 and 124, respectively. A scheduler may additionally view a display of the current primary weighted factor 120 and current secondary day/weighted factor 122.

Block 126 display to the scheduler the maximum play restrictions for primary and secondary data, side by side and with the desired numbers. Fields 127 and 129 may be used by the scheduler to input new, desired weighted factors for the primary and secondary values, respectively. The scheduler may use buttons 128 and 130 to submit the new primary and secondary weighting factor and maximum play data.

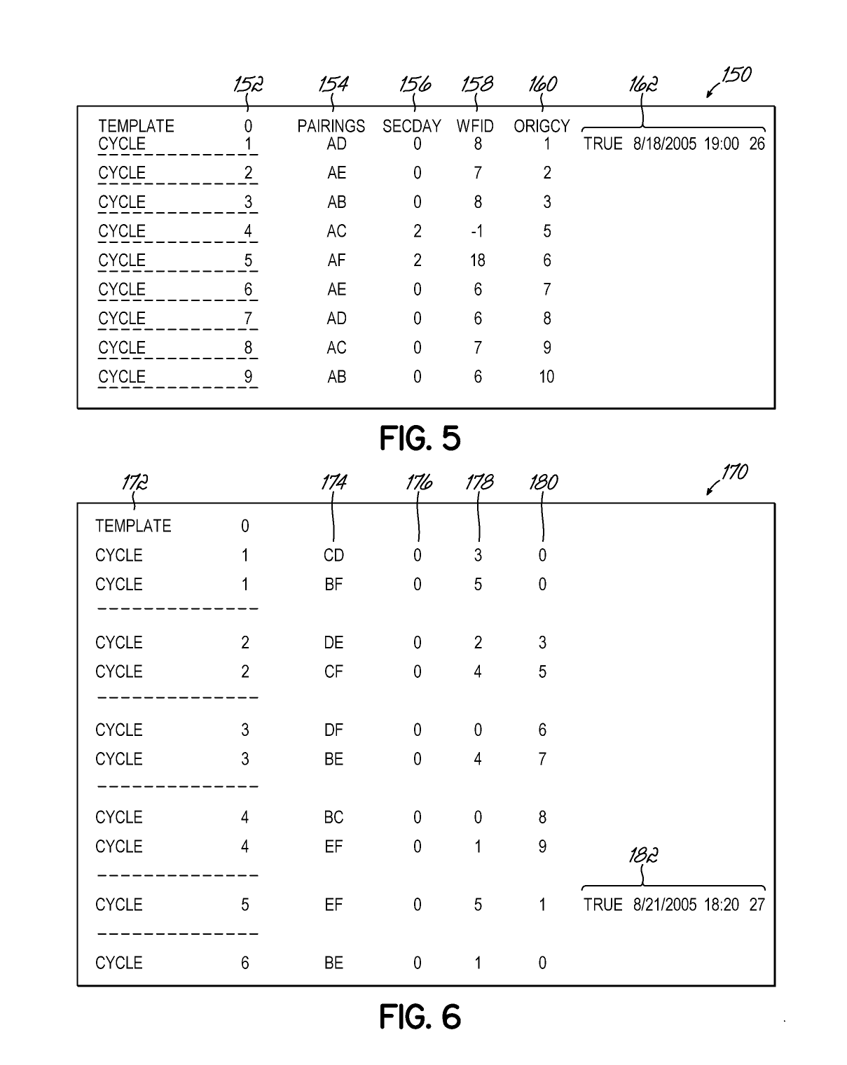

FIG. 5 shows a partial template 150 that may be generated by the system 10 of FIG. 1 in accordance with the underlying principals of the present invention. More particularly, the template 150 is the type that may be generated in accordance with the processes associated with block 68 of FIG. 2. As shown, the template 150 includes secondary match-up/pairing information associated with a league.

The pairing information in the template 150 is for an exemplary six team, nine game league for which primary and secondary allocation information has been entered as user input. Such input may be received at an interface 80 similar to that shown in FIG. 3. In the example, team A is allocated zero primary allocations and nine secondary allocations. Team B is allocated six primary pairings and two secondary pairings. The user input, which may be of the type entered at block 56 of FIG. 2, may specify that teams C and D will have six and seven primary allocations, respectively, as well as two secondary allocations each. Team E has six primary allocations and two secondary allocations, while team F has seven primary allocations and one secondary allocation.

The template 150 includes a column of cycle information 152, as well as pairing information 154. Column 156 includes secondary pairing information accommodated in the template 150. Weighted factor identifiers are included in column 158. Column 160 shows original cycle information. An entry 162 in the template 150 shows preset pairing data, as well as associated date and time information.

While a number of templates such as the template 150 shown in FIG. 5 may be generated from user input data as one of a number of templates, the above combination of data may result alternatively in only a single template 150.

FIG. 6 shows another partial template 170 that may be generated by the system 10 of FIG. 1 in accordance with another programmatic constraint and the underlying principals of the present invention. The data in the template 170 of FIG. 6 may more particularly reflect the processes of block 70 of FIG. 2 and weighted constraints.

The general layout of the template 170 may be similar to that of the template 150 of FIG. 5. That is, the weighted template 170 includes a column of cycle information 172, listed pairings 174 and an unused column of secondary pairing information 176. The template 150 may also include weighted factor identifiers 178 that help drive the template 170. The weighted factor identifiers may translate into slots (not dates) that are undesirable. Original cycle information 180 may also be included in the exemplary template 170, as well as preset paring information 182.

The template 170 may be representative of one of more than 200 other weighted partial templates generated using the user input. Such user input may be entered using an interface 110 similar to that shown in FIG. 4. The values in the weighted factor identifier 178 may represent a theoretical slot, e.g., one slot of a first or last three. Based on balancing individual requests, the weighted factor ID shown should be found in the final template.

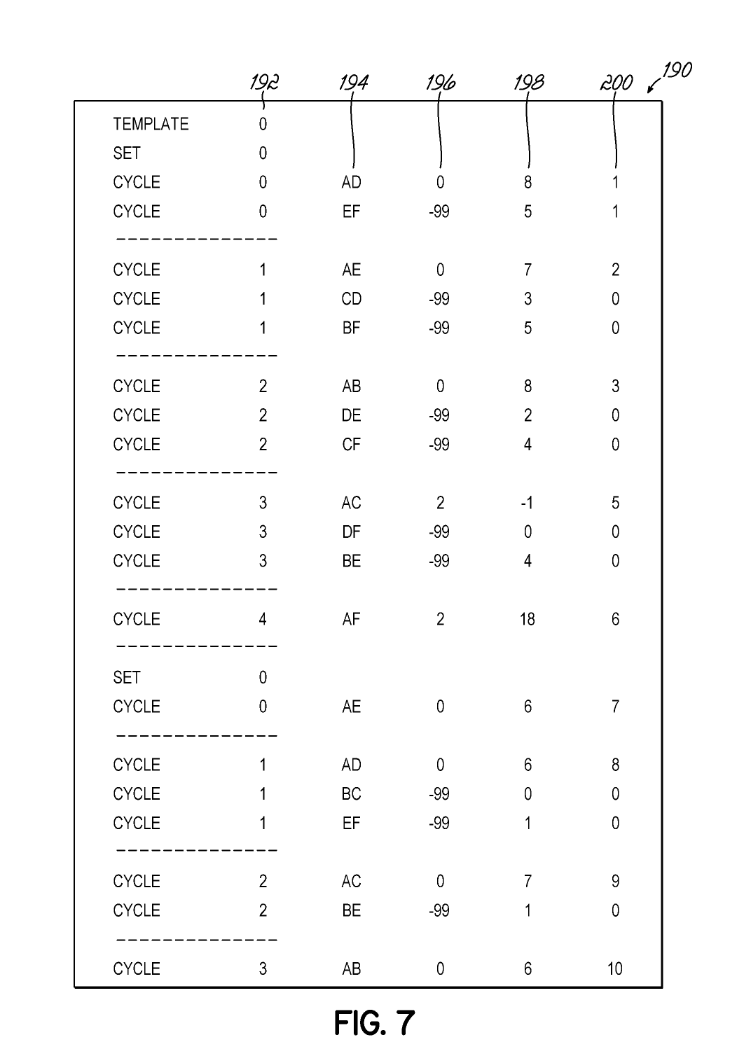

FIG. 7 shows a reconciled, or blended, template 190 that may be generated by the system 10 of FIG. 1 as a combination of the templates 150, 170 of FIGS. 5 and 6, respectively. Such a template 190 may be generated by the processes associated with block 72 of FIG. 2. As shown in FIG. 7, the template 190 includes a column of cycle information 192 and blended pairings 194. A column of secondary pairing information 196 may include two's and zero's, which correspond to secondary pairing allocations. The column 196 may also include “−99” designations that correspond to primary allocations. Weighted factor identifiers are shown in column 198. Column 200 includes original cycle information.

The template 190 may be one of a dozen blended templates determined by the system 10. The system 10 may continue to evaluate the spectrum of generated templates in terms of their potential compatibility with other templates and associated constraints in order to determine the most appropriate blended combination.

The blended template 190 of FIG. 7 may still be partial in the sense that some fields may be empty. For instance, while the constraints found in the templates of FIGS. 5 and 6 are met in the reconciled template 190 of FIG. 7, some pairings are missing. With a six team league, any cycle that does not have three pairings per cycle may require the program code to fill in the blank to generate the final full template.

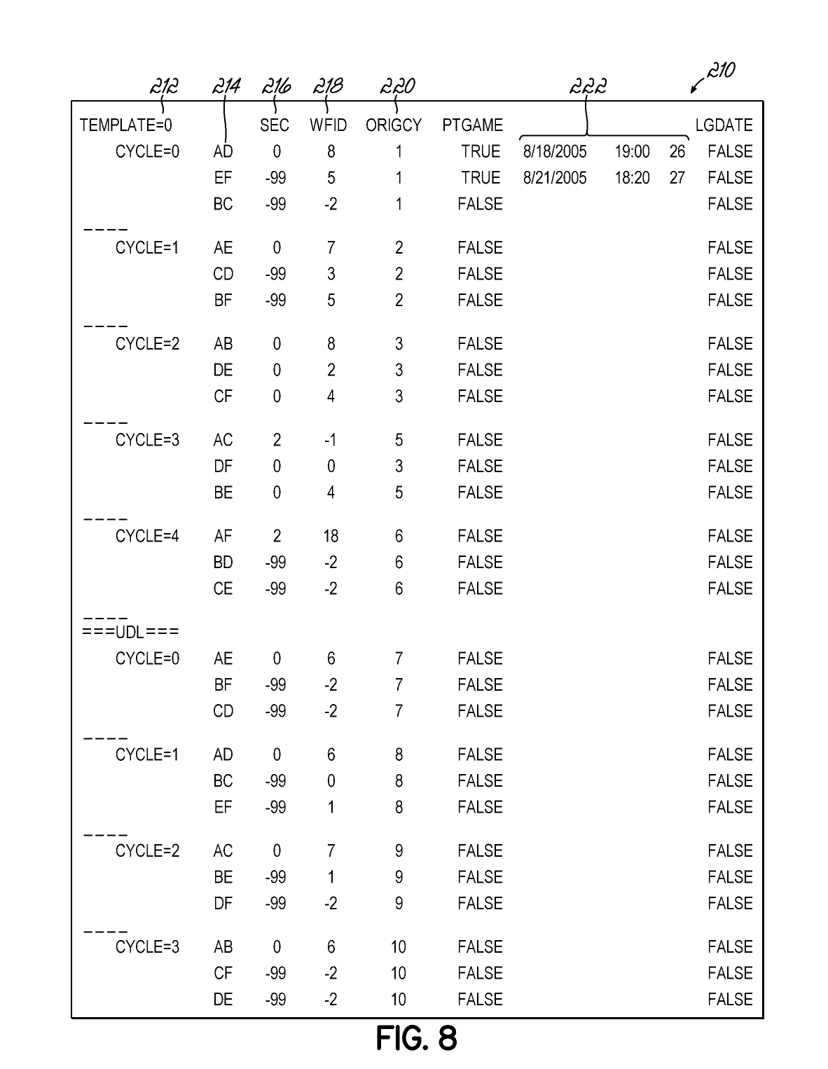

FIG. 8 shows such a final template 210 as may be generated by the system 10 of FIG. 1 in accordance with the underlying principals of the present invention. FIG. 8 includes columns having cycle information 212, complete pairings 214, and secondary allocation information 216. The template 210 also includes weighted factor identifiers 218, original cycle information 220 and preset or otherwise stipulated match information at column 222.

While the present invention has been illustrated by a description of various embodiments and while these embodiments have been described in considerable detail, it is not the intention of the Applicant to restrict, or in any way limit, the scope of the appended claims to such detail. For instance, embodiments may generate multiple templates in the course of a scheduling operation. The system 10 may create a primary/secondary working template. The system may use that template to create a master template for the leagues with the league group. The system 10 may then integrate or enter already scheduled games into the master template. The system may receive individual team requests, then the system may match the template to actual times and dates. As such, additional advantages and modifications will readily appear to those skilled in the art.

The invention in its broader aspects is therefore not limited to the specific details, representative apparatus and method, and illustrative example shown and described. For example, logic used for crossover games may include a splitting of two teams playing in their normal templates to play each other. If any attempts throughout the scheduling process do not work, embodiments of the program code may go in reverse order, change, and try again, e.g., change match-ups and try again; change duplicate match-ups and try again; build a new template and try again. Moreover, while the scheduling embodiments discussed herein may have particular application in the context of sporting events, the underlying principles may apply equally to all other forms of meeting and event scheduling. Accordingly, departures may be made from such details without departing from the spirit or scope of applicant's general inventive concept.

What is claimed is:

1. A computer implemented method of scheduling events involving a plurality of participants, the method comprising:
receiving a plurality of constraints associated with at least one of the plurality of participants;
generating based on a first constraint of the plurality a first template comprising pairings between the participants;
generating based on another constraint of the plurality a second template comprising pairings between the participants;
reconciling the first and second templates;
populating a remaining field of the reconciled template;
automatically associating the reconciled template with a plurality of time slots associated with at least one venue at which the events are to take place; and
outputting a schedule comprising the pairings assigned to the time slots.

2. The method of claim 1, wherein generating at least one of the first and second templates further comprises generating a plurality of templates based on at least one of the constraint or the other constraint.

3. The method of claim 2, further comprising selecting at least the first or second template from among the plurality of templates.

4. The method of claim 1, further comprising automatically generating a pairing absent from the reconciled template.

5. The method of claim 1, wherein receiving the plurality of constraints further includes receiving a constraint comprising at least one of a secondary allocation and a weighted factor.

6. The method of claim 1, wherein receiving the plurality of constraints further includes receiving a constraint comprising a preference selected from a group consisting of: a date of the event, a time of day for the event, a pairing, a relative sequence of the pairing compared to another pairing, a ranking, and a venue.

7. The method of claim 1, wherein receiving the plurality of constraints further includes receiving a constraint associated with a frequency of how often a preference will be realized.

8. The method of claim 1, wherein receiving the plurality of constraints further includes receiving a constraint associated with a frequency of how often a preference will be unrealized.

9. The method of claim 1, wherein receiving the plurality of constraints further includes receiving a constraint comprising at least one of a primary and secondary allocation.

10. The method of claim 1, wherein receiving the plurality of constraints further includes receiving a constraint associated with at least one of the plurality of participants, wherein the plurality of participants belong to respective teams of different leagues.

11. The method of claim 1, further comprising assigning the constraint to at least one of a league, a team, a plurality of leagues, and a participant.

12. An apparatus, comprising:
a processor;
a memory accessible to the processor, the memory including a database storing data pertaining to a plurality of participants to be scheduled in an event; and
program code executable by the processor and configured to receive a plurality of constraints associated with at least one of the plurality of participants, to generate a first template based upon a constraint of the plurality and a second template based on another constraint of the plurality, wherein the templates comprise pairings between the participants, to reconcile the first and second templates, to associate the reconciled template with a plurality of time slots associated with at least one venue at which the events are to take place, and to output a schedule comprising the pairings assigned to the time slots.

13. The apparatus of claim 12, wherein the program code is further configured to generate a plurality of templates based on at least one of the constraint or the other constraint, and to select at least the first or second template from among the plurality of templates.

14. The apparatus of claim 12, wherein the constraint comprises a preference for a repeat pairing.

15. The apparatus of claim 12, wherein the constraint is associated with a frequency of how often a preference will be realized.

16. The apparatus of claim 12, wherein the constraint comprises a secondary allocation.

17. The apparatus of claim 12, wherein the constraint comprises a weighted factor.

18. The apparatus of claim 12, wherein the plurality of participants belong to respective teams of different leagues.

19. The apparatus of claim 10, wherein the program code is further configured to generate a pairing absent from the reconciled template.

20. A program product, comprising:
program code configured to receive a plurality of constraints associated with at least one of a plurality of participants, to generate a first template based upon a constraint of the plurality and a second template based on another constraint of the plurality, wherein the templates comprise pairings between the participants, to reconcile the first and second templates, to associate the reconciled template with a plurality of time slots associated with at least one venue at which the events are to take place, and to output a schedule comprising the pairings assigned to the time slots; and
a computer readable medium bearing the program code.
